(19) United States
(12) Patent Application Publication
(10) Pub. No.: US 2026/0211155 A1
(43) Pub. Date: Jul. 23, 2026

(54) OPTICAL ELEMENT, LIGHT GUIDE ELEMENT, AND AR DISPLAY DEVICE

(71) Applicant: Sharp Display Technology Corporation, Kameyama City (JP)

(72) Inventors: Ryosuke SAIGUSA, Kameyama City (JP); Akira SAKAI, Kameyama City (JP); Yuichi KAWAHIRA, Kameyama City (JP); Takeshi OYAMA, Kameyama City (JP)

(21) Appl. No.: 19/428,552

(22) Filed: Dec. 22, 2025

(30) Foreign Application Priority Data
Dec. 27, 2024 (JP) 2024-232015

(51) Int. Cl. G02B 1/06; F21V 8/00; G02B 1/08; G02B 27/01

(52) U.S. Cl. CPC G02B 1/06; G02B 1/08; G02B 6/0018; G02B 6/0035; G02B 27/0101

(57) ABSTRACT

Provided are an optical element including a single-layer cholesteric liquid crystal layer capable of reflecting red, green, and blue light components, and a light guide element and an AR display device each including the optical element. The optical element includes a cholesteric liquid crystal layer containing a polymer of a polymerizable liquid crystal compound and a chiral agent. The cholesteric liquid crystal layer includes, within a plane, a first reflective region having a reflectance peak that falls within a wavelength range of 400 to 550 nm, and a second reflective region having a reflectance peak that is different from the reflectance peak of the first reflective region and falls within a wavelength range of 550 to 700 nm. The cholesteric liquid crystal layer has a smaller thickness in the first reflective region than in the second reflective region.

### CROSS-REFERENCE TO RELATED APPLICATIONS

The present application claims priority under 35 U.S.C. § 119 to Japanese Patent Application No. 2024-232015 filed on Dec. 27, 2024, the contents of which are incorporated herein by reference in their entirety.

### BACKGROUND

### Technical Field

The following disclosure relates to optical elements, light guide elements, and AR display devices.

### Description of Related Art

There has been active research and development of augmented reality (AR) display devices that overlay images onto the real-world view. For example, AR glasses have been proposed that overlay video content from a display device onto the user's view of the real world by directing display light into one end of a light guide plate and allowing the light to propagate and exit from the other end. Some of these AR glasses incorporate a diffraction element that utilizes a liquid crystal layer containing a chiral agent. Specifically, it has been known to utilize a cholesteric liquid crystal layer having a liquid crystal alignment pattern in which the optical axis derived from the liquid crystal compound continuously rotates along at least one in-plane direction (for example, US 2021/0397008 A1, WO 2019/189852, WO 2020/122119).

### SUMMARY

(1) One embodiment of the present invention is directed to an optical element, including a cholesteric liquid crystal layer containing a polymer of a polymerizable liquid crystal compound and a chiral agent, the cholesteric liquid crystal layer including, within a plane, a first reflective region having a reflectance peak that falls within a wavelength range of 400 to 550 nm, and a second reflective region having a reflectance peak that is different from the reflectance peak of the first reflective region and falls within a wavelength range of 550 to 700 nm, the cholesteric liquid crystal layer having a smaller thickness in the first reflective region than in the second reflective region.
(2) In an embodiment of the present invention, the optical element includes the structure (1), and one of the first reflective region and the second reflective region is distributed in a plurality of partial regions, and the other of the first reflective region and the second reflective region surrounds each of the plurality of partial regions.
(3) In an embodiment of the present invention, the optical element includes the structure (2), and a region in the cholesteric liquid crystal layer other than the plurality of partial regions corresponds to the other of the first reflective region and the second reflective region.
(4) In an embodiment of the present invention, the optical element includes the structure (1), (2), or (3), and in the cholesteric liquid crystal layer, reflectance at a wavelength of 450 nm in the first reflective region is higher than reflectance at a wavelength of 650 nm in the second reflective region, and an area of the first reflective region is smaller than an area of the second reflective region.
(5) In an embodiment of the present invention, the optical element includes the structure (1), (2), or (3), and in the cholesteric liquid crystal layer, reflectance at a wavelength of 450 nm in the first reflective region is lower than reflectance at a wavelength of 650 nm in the second reflective region, and an area of the first reflective region is greater than an area of the second reflective region.
(6) In an embodiment of the present invention, the optical element includes the structure (1), (2), (3), (4), or (5), and the cholesteric liquid crystal layer includes, within the plane, a low-reflective region having a lower visible reflectance than the first reflective region and the second reflective region.
(7) In an embodiment of the present invention, the optical element includes the structure (6), one of the first reflective region and the second reflective region is distributed in a plurality of first partial regions, the low-reflective region is distributed in a plurality of second partial regions, and a region in the cholesteric liquid crystal layer other than the plurality of first partial regions and the plurality of second partial regions corresponds to the other of the first reflective region and the second reflective region.
(8) Another embodiment of the present invention is directed to a light guide element, including: a light guide plate; a light incident-side optical element mounted on a light incident side of the light guide plate; and a light emission-side optical element mounted on a light emission side of the light guide plate, at least one of the light incident-side optical element or the light emission-side optical element is the optical element including the structure (1), (2), (3), (4), (5), (6), or (7).
(9) In an embodiment of the present invention, the light guide element includes the structure (8), the light emission-side optical element includes, within a plane, the cholesteric liquid crystal layer including a low-reflective region having a lower visible reflectance than the first reflective region and the second reflective region, and in the cholesteric liquid crystal layer, an area proportion of the low-reflective region is greater in a first region than in a second region which is farther from the light incident side of the light guide plate than the first region.
(10) Yet another embodiment of the present invention is directed to an AR display device, including: the light guide element including the structure (8) or (9); and a display module facing the light incident-side optical element.

The present disclosure can provide an optical element including a single-layer cholesteric liquid crystal layer capable of reflecting red, green, and blue light components, and a light guide element and an AR display device each including the optical element.

### BRIEF DESCRIPTION OF THE DRAWINGS

FIG. 1 is a schematic cross-sectional view of an optical element according to Embodiment 1.

FIG. 2 is a schematic perspective view of the optical element according to Embodiment 1.

FIG. 3 is a graph showing the reflection spectrum of a typical single-layer cholesteric liquid crystal layer.

FIG. 4 is a graph showing changes in the reflection spectrum of a cholesteric liquid crystal layer depending on the presence or absence of solvent application.

FIG. 5 is a schematic cross-sectional view of a light guide element according to Embodiment 2.

FIG. 6 is a diagram illustrating occurrence of luminance unevenness when the reflectance of a coupler is uniform within the plane.

FIG. 7 is a schematic perspective view of an optical element according to Embodiment 3.

FIG. 8 is a graph showing the reflectance of a cholesteric liquid crystal layer in Comparative Example 1.

FIG. 9 is a graph showing the reflectance of a cholesteric liquid crystal layer in Comparative Example 2.

FIG. 10 is a graph showing the reflectance of cholesteric liquid crystal layers in Comparative Examples 1 and 3.

FIG. 11 is a flow diagram illustrating the mechanism by which the reflection wavelength of a cholesteric liquid crystal layer is shifted by applying a solvent to a partially cured polymerizable liquid crystal compound.

FIG. 12 is a graph showing the reflectance of a cholesteric liquid crystal layer in Comparative Example 4.

FIG. 13 is a diagram showing curing treatment performed on a polymerizable liquid crystal compound in Example 1.

FIG. 14 is a graph comparing the reflectance values of the cholesteric liquid crystal layers in Example 1, Comparative Example 3, and Comparative Example 4.

### DETAILED DESCRIPTION

A cholesteric liquid crystal layer has a nature of selectively reflecting visible light. To improve the display quality of AR glasses, a diffraction element including a cholesteric liquid crystal layer capable of reflecting all red (R), green (G), and blue (B) components of visible light has been demanded. A stack of cholesteric liquid crystal layers selectively reflecting light components with different wavelengths can reflect RGB light components. However, a technique enabling a single-layer cholesteric liquid crystal layer to reflect RGB light components has been demanded.

In response to the above issues, the present disclosure aims to provide an optical element including a single-layer cholesteric liquid crystal layer capable of reflecting red, green, and blue light components, and a light guide element and an AR display device each including the optical element.

Hereinafter, embodiments of the present invention are described with reference to the drawings. The present invention is not limited to the following embodiments. The configurations of the embodiments may be combined or modified as appropriate without departing from the gist of the present invention.

In the following description, identical or functionally similar components are denoted by the same reference signs across different figures, and repeated descriptions thereof are omitted as appropriate.

Herein, “Re (λ)” represents the in-plane phase difference introduced at wavelength λ.

### Embodiment 1

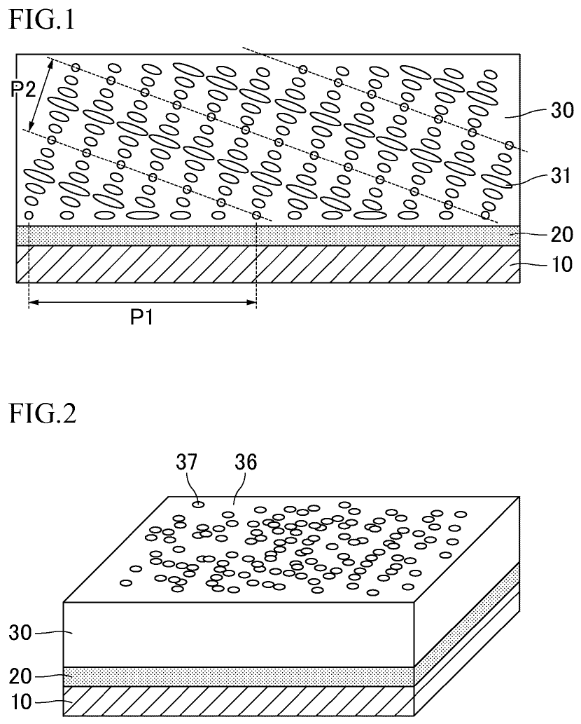

FIG. 1 is a schematic cross-sectional view of an optical element according to Embodiment 1. FIG. 2 is a schematic perspective view of the optical element according to Embodiment 1. As shown in the figures, the optical element according to Embodiment 1 has a configuration in which an alignment film 20 and a cholesteric liquid crystal layer 30 are stacked on a support 10.

### Support

The support 10 may be any member that supports the alignment film 20 and the cholesteric liquid crystal layer 30. Examples include glass substrates and resin substrates. When the optical element in the present embodiment is applied to a light guide element, the support 10 is preferably a light guide plate.

### Alignment Film

The alignment film 20 has a patterned in-plane alignment regulating force. Specifically, the alignment film 20 exerts an alignment regulating force that induces a pattern in which the slow axes of the molecules of a polymerizable liquid crystal compound 31 in the cholesteric liquid crystal layer 30 rotate periodically within the plane. The pattern period, P1, is adjusted, for example, to fall within the range of 200 to 600 nm.

The material of the alignment film 20 can be a polymer with a polyimide structure in the main chain, a polymer with a polyamic acid structure in the main chain, a polymer with a polysiloxane structure in the main chain, or any other material that is common in the field of liquid crystal panels. The alignment film 20 can be formed by coating the support 10 with an alignment film material. The coating method is not limited and may be, for example, flexographic printing, inkjet coating, or another method.

The alignment film 20 may be of any type, and may be a rubbing alignment film having been subjected to rubbing as an alignment treatment, or a photoalignment film having a photo-functional group and having been subjected to photoalignment treatment as an alignment treatment. In terms of patterning of the in-plane alignment regulating force in a complicated pattern, the alignment film 20 is preferably a photoalignment film.

### Cholesteric Liquid Crystal Layer

The cholesteric liquid crystal layer 30 is obtained by polymerizing the polymerizable liquid crystal compound 31 containing a chiral agent. The chiral agent aligns the molecules of the polymerizable liquid crystal compound 31 in a direction continuously varying along the thickness direction of the cholesteric liquid crystal layer 30, forming a helical molecular alignment. The helical molecular alignment is stabilized by polymerization. Herein, the period corresponding to one full rotation in a helical molecular alignment is referred to as the “helical pitch” or “chiral period”. A helical pitch P2 refers to the length along the helical axis over which the molecular orientation of the polymerizable liquid crystal compound 31 rotates 180°. The helical pitch P2 is adjusted, for example, within the range of 220 to 900 nm.

The helical axis is preferably tilted relative to the normal to the surface of the cholesteric liquid crystal layer 30. In other words, when the direction parallel to the surface of the cholesteric liquid crystal layer 30 is defined as 0 degrees and the direction normal to the surface is defined as 90 degrees, the orientation of the helical axis (helical axis tilt angle) is selectable as appropriate within the range of 0 to 90 degrees depending on the function of the optical element of the present embodiment. For example, when the optical element of the present embodiment is applied to a light guide element, the helical axis tilt angle is preferably 40 degrees or greater and less than 80 degrees.

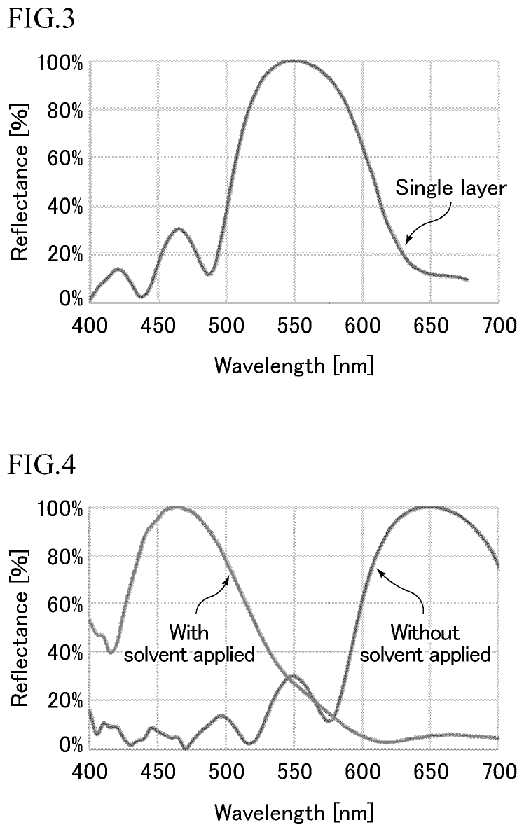

FIG. 3 is a graph showing the reflection spectrum of a typical single-layer cholesteric liquid crystal layer. As shown in the figure, in many cases, a typical single-layer cholesteric liquid crystal layer exhibits only one distinct reflectance peak within the visible spectrum, and is often designed so that the reflectance peak appears around a wavelength of 550 nm, which corresponds to the center of the visible spectrum. In contrast, in the present embodiment, the cholesteric liquid crystal layer 30 includes, within the plane, a first reflective region 37 having a reflectance peak that falls within a wavelength range of 400 to 550 nm, and a second reflective region 36 having a reflectance peak that is different from the reflectance peak of the first reflective region 37 and falls within a wavelength range of 550 to 700 nm. When light including a large proportion of wavelength components in the wavelength range of 400 to 550 nm reflected by the first reflective region 37 is mixed with light including a large proportion of wavelength components in the wavelength range of 550 to 700 nm reflected by the second reflective region 36, the reflectance of the cholesteric liquid crystal layer 30 can be made more uniform across the entire visible spectrum.

The term “reflectance peak” refers to a local maximum in reflectance of 40% or higher, based on normalization where the maximum reflectance within the wavelength range of 400 to 700 nm is set to 100%. The reflectance peak preferably refers to a local maximum in reflectance of 50% or higher, more preferably a local maximum in reflectance of 60% or higher, still more preferably a local maximum in reflectance of 70% or higher.

The reflectance peak in the first reflective region 37 preferably falls within the wavelength range of 400 to 500 nm, more preferably within the wavelength range of 420 to 480 nm. The first reflective region 37 mainly reflects blue light. The reflectance peak in the second reflective region 36 preferably falls within the wavelength range of 600 to 700 nm, more preferably within the wavelength range of 620 to 680 nm. The second reflective region 36 mainly reflects red light. The difference between the reflectance peak in the first reflective region 37 and the reflectance peak in the second reflective region 36 is preferably 50 nm or more, more preferably 100 nm or more.

In the cholesteric liquid crystal layer 30, the helical pitch of the polymerizable liquid crystal compound 31 differs between the first reflective region 37 and the second reflective region 36, leading to different reflectance peak wavelengths. The helical pitch is set shorter in the first reflective region 37 than in the second reflective region 36. The concentration of the chiral agent is set higher in the first reflective region 37 than in the second reflective region 36. The helical pitch of the polymerizable liquid crystal compound 31 in the first reflective region 37 is preferably 120 nm or more and 230 nm or less. The helical pitch of the polymerizable liquid crystal compound 31 in the second reflective region 36 is preferably 170 nm or more and 290 nm or less.

The cholesteric liquid crystal layer 30 has a smaller thickness in the first reflective region 37 than in the second reflective region 36. The present inventors examined a method of forming, within the plane, regions with different concentrations of the chiral agent in the polymerizable liquid crystal compound 31 to form the first reflective region 37 and the second reflective region 36 within the plane. As a result, the inventors found a method including forming regions with different degrees of curing of the cholesteric liquid crystal layer 30 within the plane and then applying a solvent to the cholesteric liquid crystal layer 30. FIG. 4 is a graph showing changes in the reflection spectrum of a partially cured cholesteric liquid crystal layer with a solvent applied. As shown in the figure, when a solvent is applied to the partially cured cholesteric liquid crystal layer 30, the reflectance peak is shifted toward shorter wavelengths. This is presumably because application of a solvent to a region with a low degree of curing of the cholesteric liquid crystal layer 30 induces a phenomenon in which the polymerizable liquid crystal compound 31 is diffused toward the solvent, while the chiral agent is diffused toward the substrate but not toward the solvent. This phenomenon causes, in a region with a low degree of curing, the concentration of the chiral agent to increase and the helical pitch to be shorter, while decreasing the thickness of the cholesteric liquid crystal layer 30. In contrast, in a region with a high degree of curing, the phenomenon does not cause any change in the concentration of the chiral agent and thus in the helical pitch, nor does it cause any change in the thickness of the cholesteric liquid crystal layer 30. Therefore, in formation of the cholesteric liquid crystal layer 30, a region with a high degree of curing is formed into a second reflective region by setting the helical pitch longer such that the reflectance peak appears at a longer wavelength than the reflection spectrum of the typical cholesteric liquid crystal layer 30 shown in FIG. 3, while a region with a low degree of curing is formed into a first reflective region 37 by applying a solvent to shift the reflectance peak toward shorter wavelengths. This enables the single-layer cholesteric liquid crystal layer 30 to reflect RGB light components.

The smaller thickness in the first reflective region 37 than in the second reflective region 36 is advantageous in making the RGB light reflectance values uniform. The reflectance of the polymerizable liquid crystal compound 31 with a chiral agent depends on the number of rotations of the helical molecular alignment in the normal direction of the cholesteric liquid crystal layer 30. A shorter wavelength of selectively reflected light corresponds to a shorter helical pitch, which enables high reflectance even in a region with a small thickness of the layer. Thus, a simultaneous occurrence of a shift toward shorter wavelengths and a decrease in the thickness of the layer upon solvent application indicates an advantageous trend toward uniform RGB light reflectance values.

To obtain a cholesteric liquid crystal layer 30 with a wide range of wavelengths of light capable of being reflected, the method including forming regions with different degrees of curing of the cholesteric liquid crystal layer 30 within the plane and then applying a solvent to the cholesteric liquid crystal layer 30 is advantageous in terms of workability and cost, as it requires only one cholesteric liquid crystal layer 30 and alignment control of only one layer. In contrast, when cholesteric liquid crystal layers with different wavelengths of light capable being reflected are stacked to widen the range of wavelengths of light capable of being reflected, a plurality of polymerizable liquid crystal compounds are required, likely increasing the cost. Additionally, alignment control of the second and subsequent cholesteric liquid crystal layers is difficult as compared to the alignment control of the first cholesteric liquid crystal layer. Furthermore, when a cholesteric liquid crystal layer is coated with a different polymerizable liquid crystal compound, the coating liquid consisting of the different polymerizable liquid crystal compound tends to be repelled.

The solvent for forming the first reflective region 37 and the second reflective region 36 may be any solvent that can dissolve the polymerizable liquid crystal compound 31 and the chiral agent may be used. Examples thereof include propylene glycol monomethyl ether acetate (PGMEA). When the cholesteric liquid crystal layer 30 is formed by applying a composition containing the polymerizable liquid crystal compound 31 and the chiral agent on the alignment film 20, a solvent for forming the cholesteric liquid crystal layer 30 may be used for forming the first reflective region 37 and the second reflective region 36.

In the cholesteric liquid crystal layer 30, the difference in thickness between the first reflective region 37 and the second reflective region 36 is, for example, 0.1 μm or more and 0.5 μm or less, preferably 0.2 μm or more and 0.4 μm or less. In the cross-sectional view of FIG. 1, the difference in thickness between the first reflective region 37 and the second reflective region 36 is omitted.

As shown in the figure, the first reflective region 37 is distributed in a plurality of partial regions, and the second reflective region 36 surrounds each of the plurality of partial regions. Conversely, the second reflective region 36 may be distributed in a plurality of partial regions and the first reflective region 37 may surround each of the plurality of partial regions. In the present embodiment, preferably, one of the first reflective region 37 and the second reflective region 36 is distributed in a plurality of partial regions, and the other of the first reflective region 37 and the second reflective region 36 surrounds each of the plurality of partial regions. This arrangement allows white light incident on the optical element to be perceived as white light by the observer, without the light component reflected by the first reflective region 37 and the light component reflected by the second reflective region 36 being perceived as different color light components. As shown in the figures, when one of the first reflective region 37 and the second reflective region 36 in the cholesteric liquid crystal layer 30 is distributed in a plurality of partial regions, a region other than the plurality of partial regions may correspond to the other of the first reflective region 37 and the second reflective region 36.

The arrangement density of the plurality of partial regions is not limited and may be 10 regions/mm² or more and 100 regions/mm² or less, for example.

The size of each of the plurality of partial regions is not limited and may be 0.005 mm² or more and 0.05 mm² or less, for example.

The shape of each of the plurality of partial regions is not limited and may be a circle or square, for example.

Preferred embodiments of the cholesteric liquid crystal layer 30 include: (1) an embodiment in which the reflectance at a wavelength of 450 nm in the first reflective region 37 is higher than the reflectance at a wavelength of 650 nm in the second reflective region 36, and the area of the first reflective region 37 (the total area of the first reflective region 37 in the cholesteric liquid crystal layer 30 in a plan view) is smaller than the area of the second reflective region 36 (the total area of the second reflective region 36 in the cholesteric liquid crystal layer 30 in a plan view); and (2) an embodiment in which the reflectance at a wavelength of 450 nm in the first reflective region 37 is smaller than the reflectance at a wavelength of 650 nm in the second reflective region 36, and the area of the first reflective region 37 (the total area of the first reflective region 37 in the cholesteric liquid crystal layer 30 in a plan view) is greater than the area of the second reflective region 36 (the total area of the second reflective region 36 in the cholesteric liquid crystal layer 30 in a plan view). In these embodiments, the area of the region with higher reflectance is made small, so that the reflectance in the visible spectrum can be more easily made uniform.

The polymerizable liquid crystal compound 31 may be of any type, and conventionally known polymerizable liquid crystal compounds can be used, with those curable by ultraviolet (UV) irradiation being suitable. The polymerizable liquid crystal compounds are also called reactive mesogens (RMs).

Examples of the polymerizable liquid crystal compound 31 include polymers each having a structure with both a mesogen group and a photoreactive group in its side chain and having an acrylate, methacrylate, maleimide, N-phenylmaleimide, siloxane, or another structure in its main chain. The mesogen group may be a biphenyl group, a terphenyl group, a naphthalene group, a phenylbenzoate group, an azobenzene group, or a derivative of any of these groups. The photoreactive group may be a cinnamoyl group, a chalcone group, a cinnamylidene group, a β-(2-phenyl)acryloyl group, a cinnamic acid group, or a derivative of any of these groups.

The polymerizable liquid crystal compound 31 may be a homopolymer defined by a single repeating unit, or a copolymer defined by two or more repeating units with different side chain structures. The term “copolymer” includes all of alternating, random, and graft types.

The chiral agent may be of any type, and conventionally known chiral agents can be used. The chiral agent may be, for example, S-811 (available from Merck KGaA).

The optical element according to Embodiment 1, including the alignment film 20 with the patterned in-plane alignment regulating force and the cholesteric liquid crystal layer 30 aligned by the alignment film 20, is categorized as an element called polymerization volume hologram (PVH). A PVH used in light guide plate applications is referred to as a coupling element or a coupler. The optical element according to Embodiment 1 is used as a coupling element in applications such as AR glass applications. Also, the optical element according to Embodiment 1 can be used as a diffraction grating, and is preferably a diffraction element with tilted Bragg planes.

### Embodiment 2

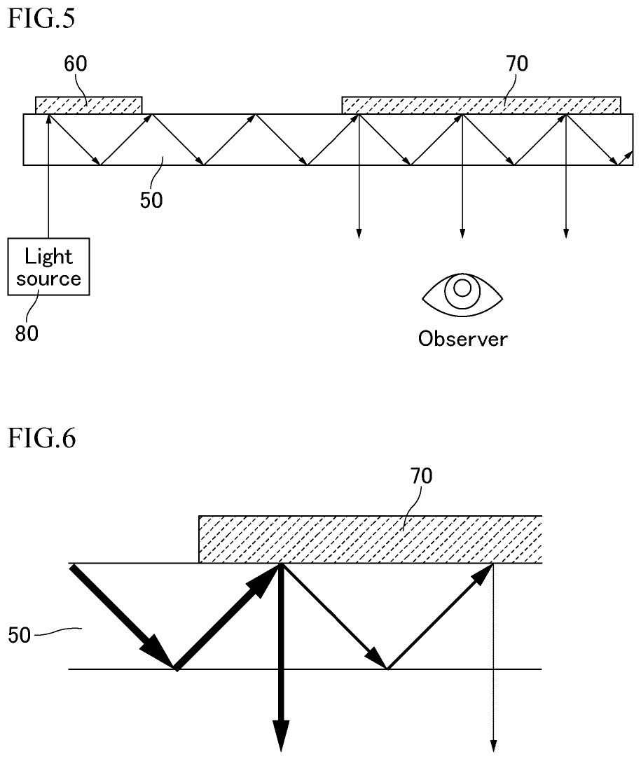

FIG. 5 is a schematic cross-sectional view of a light guide element according to Embodiment 2. As shown in FIG. 5, the light guide element according to Embodiment 2 includes a light guide plate 50, a light incident-side optical element (first coupling element) 60 mounted on the light incident side of the light guide plate 50, and a light emission-side optical element (second coupling element) 70 mounted on the light emission side of the light guide plate 50. For example, when the length of the light guide plate 50 in the lateral direction in FIG. 5 is 70 mm, the light incident-side optical element 60 is arranged at a position 10 mm to 15 mm from an end portion (left end in FIG. 5) of the light guide plate 50, and the light emission-side optical element 70 is arranged at a position 40 mm to 60 mm from the end portion (left end in FIG. 5) of the light guide plate 50. The arrows in FIG. 5 indicate the path of light incident on the light guide plate.

The light guide plate 50 can be one conventionally known in the field of liquid crystal display devices. In the light guide element according to Embodiment 2, at least one of the light incident-side optical element 60 or the light emission-side optical element 70 is the optical element according to Embodiment 1. In particular, the light emission-side optical element 70 is preferably the optical element according to Embodiment 1.

The light guide element according to Embodiment 2 is suitable for augmented reality (AR) display devices. When an AR display device incorporates the light guide element according to Embodiment 2, a display module is arranged as a light source 80 at a position facing the light incident-side optical element 60. The display module (the light source 80) may face the light incident-side optical element 60 across the light guide plate 50 as shown in FIG. 5, or may face the light incident-side optical element 60 without the light guide plate 50 (That is, the display module (the light source 80) may be positioned on a side opposite to the light guide plate 50 with respect to the light incident-side optical element 60). The display module may be any display module that displays contents compatible with AR technology. For example, a thin-profile display such as a liquid crystal display module or an organic EL display module can be used.

The AR display device including the light guide element according to Embodiment 2 is preferably AR glasses shaped like eyeglasses. In AR glasses, light from the display module enters the light guide plate 50, and is guided in the direction designed by the light incident-side optical element (incoupler) 60 mounted on the light incident side of the light guide plate 50. Thereafter, the light propagates through the inside of the light guide plate 50, from one end (the end where the light incident-side optical element 60 is arranged) to the other end (the end where the light emission-side optical element 70 is arranged), while being repeatedly reflected at the interfaces between the light guide plate 50 and air. The light having reached the light emission side of the light guide plate 50 is reflected by the light emission-side optical element (outcoupler) 70 to enter the eyes of the observer (user), so that the observer can perceive the images on the display module.

When the light guide element is applied to AR glasses, the outcoupler 70 is preferably larger than the light receiving area of the human eye. The size of the outcoupler 70 in the horizontal direction is 20 mm, for example. When the reflectance of the outcoupler 70 is lower than 100%, light that enters the outcoupler 70 is split into a component that is visible to the observer and a component that continues to propagate through the light guide plate. The continuous propagation allows light to be emitted from the outcoupler 70 at various positions within the plane, from which the light enters the observer's eyes. This allows the observer to see images even when their eyes move. The region where the observer can see the video even when their eyes move is referred to as “eye box”. Preferably, 95% or more of light from the light source is emitted into the eye box, for example, by adjusting the size of the outcoupler 70 in the horizontal direction, reflectance, and other conditions.

Also, when the light guide element is applied to AR glasses, for example, the thickness of the light guide plate 50 is set to 1 mm, and the diffraction angles (for example, diffraction angles for light with a wavelength of 550 nm) of the incoupler 60 and the outcoupler 70 are set to 45°. The diffraction angles of the incoupler 60 and the outcoupler 70 depend on the pattern period P1 (see FIG. 1). When entering the main surface of the light guide plate 50 from the normal direction, light is totally reflected at an angle of 45° within the light guide plate 50 by the incoupler 60, and is emitted in the normal direction by the outcoupler 70. With the reflectance of the outcoupler 70 being adjusted to 30%, 95% or more of light from the light source is emitted into the eye box.

In order to improve the display quality of AR glasses, the coupler needs to function properly with RGB light components. However, since the reflection spectrum of a PVH has a certain width, similar to the selective reflection seen in typical cholesteric liquid crystals, a PVH cannot reflect light across the entire RGB wavelength range. The present inventors therefore examined a method of stacking PVHs with different chiral pitches. However, the inventors found that alignment disturbance in the second and subsequent layers of the polymerizable liquid crystal compound and repellence of the coating liquid occur, meaning that the method involves challenges such as chiral pitch control, an increased number of processes, and increased cost. In response to the challenges, the present inventors found that when a partially cured polymerizable liquid crystal compound comes into contact with a solvent, the reflection wavelength is shifted toward shorter wavelengths, and the thickness of the layer decreases. Based on these findings, the present inventors arrived at forming a partially cured region and a fully cured region within the plane and then applying a solvent to the compound, thereby achieving a single-layer PVH with a unform reflectance for light across the entire RGB wavelength range.

### Embodiment 3

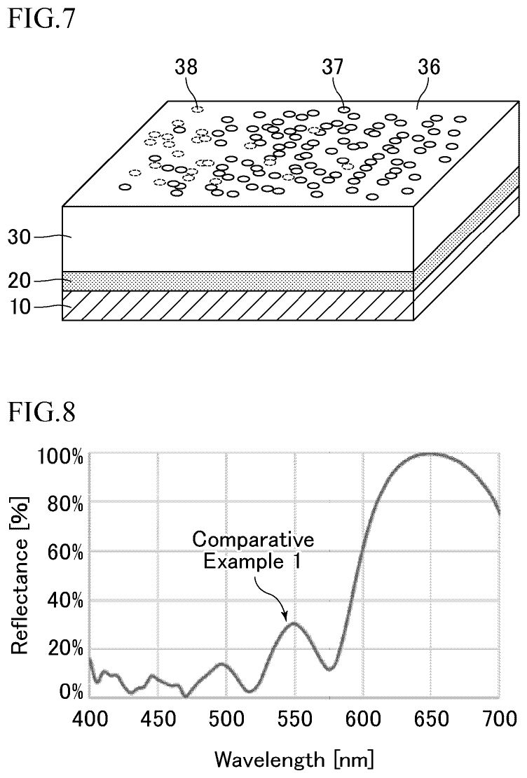

FIG. 6 is a diagram illustrating occurrence of luminance unevenness when the reflectance of a coupler is uniform within the plane. FIG. 7 is a schematic perspective view of an optical element according to Embodiment 3. The optical element according to Embodiment 3 has the same configuration as the optical element according to Embodiment 1, except for including, within the plane of the cholesteric liquid crystal layer 30, a low-reflective region 38 having a lower visible reflectance than the first reflective region 37 and the second reflective region 36. The low-reflective region 38 can add functions to the optical element. For example, in the case of an optical element used in combination with the light guide plate 50, the luminance distribution of the emission light can be made more uniform by increasing the area of the low-reflective region 38 at a position closer to the light incident portion. One of the first reflective region 37 and the second reflective region 36 (in the case of FIG. 7, the first reflective region 37) may be distributed in a plurality of first partial regions, the low-reflective region 38 may be distributed in a plurality of second partial regions, and a region in the cholesteric liquid crystal layer other than the plurality of first partial regions and the plurality of second partial regions may correspond to the other of the first reflective region 37 and the second reflective region 36 (in the case of FIG. 7, the second reflective region 36).

The low-reflective region 38 can be formed, for example, by a method including forming a region (for example, uncured region) with a lower degree of curing of the polymerizable liquid crystal compound than the first reflective region 37, and then applying a solvent to the compound. This is because in the region with a lower degree of curing of the polymerizable liquid crystal compound than the first reflective region 37, the helical pitch is shorter than that in the first reflective region 37 and the reflectance peak appears at a wavelength shorter than 400 nm.

The visible reflectance corresponds to the average reflectance in the wavelength range of 400 to 700 nm.

The optical element according to Embodiment 3 may be applied to the light emission-side optical element 70 in the light guide element according to Embodiment 2. This can achieve a configuration in which the light emission-side optical element 70 includes a cholesteric liquid crystal layer 30 having a low-reflective region 38, and the area proportion of the low-reflective region 38 is greater in a first region of the cholesteric liquid crystal layer 30 (a region closer to the light incident side of the light guide plate 50; for example, a region including the end portion closest to the light incident side of the light guide plate 50 in the cholesteric liquid crystal layer 30) than in a second region of the cholesteric liquid crystal layer 30 (for example, a region including the end portion farthest from the light incident side of the light guide plate 50 in the cholesteric liquid crystal layer 30) which is farther from the light incident side of the light guide plate 50 than the first region of the cholesteric liquid crystal layer 30. This configuration can improve the display quality of the AR glasses.

In order to improve the display quality of AR glasses, the AR glasses preferably allow the observer to see the video on the display module even when their eyes move. When light is applied to a plurality of positions of the coupler, the range within which the observer can see the video on the display module (eye box) can be widened. However, as shown in FIG. 6, when the reflectance of the coupler is uniform within the plane, the intensity of light emitted from the light guide plate 50 is higher at a position closer to the light source, meaning that in-plane luminance unevenness may occur. In contrast, when the optical element (coupler) according to Embodiment 3 is used in AR glasses, the luminance in the eye box can be made uniform within the visible spectrum from 400 to 700 nm.

### EXAMPLES

### Examples and Comparative Examples

Hereinbelow, examples and comparative examples are described, but the present invention is not limited to these examples.

### Comparative Example 1

In Comparative Example 1, the selective reflection wavelength of a sample with a single-layer film of a polymerizable liquid crystal compound containing a chiral agent was evaluated. The sample was produced by the following procedure.
(1) A photoisomerization-type photoalignment film was formed on a glass substrate.
(2) The photoalignment film was irradiated with polarized ultraviolet (UV) light with a wavelength of 365 nm at 100 mJ/cm². Then, the photoalignment film was baked for 20 minutes in an oven at 160° C.
(3) The photoalignment film was coated with a polymerizable liquid crystal compound containing a chiral agent using a spin coater rotating at 1000 rpm. The concentration of the chiral agent was adjusted such that the selective reflection wavelength would be 650 nm. The polymerizable liquid crystal compound exhibited positive wavelength dispersion, with the following relationships observed: Re (450 nm)/Re (550 nm)≈1.14; and Re (650 nm)/Re (550 nm)≈0.94.
(4) The applied polymerizable liquid crystal compound was irradiated with non-polarized UV light with a wavelength of 365 nm at 3 J/cm² to cure the polymerizable liquid crystal compound, whereby the sample was completed.

The completed sample had a configuration in which a photoalignment film and a cholesteric liquid crystal layer were stacked on a glass substrate. The cholesteric liquid crystal layer contained a polymer of a polymerizable liquid crystal compound and a chiral agent.

### (Evaluation)

The thickness of the cholesteric liquid crystal layer was measured using non-contact 3D measuring instrument “NH-3MA” available from Mitaka Kohki Co., Ltd. The measurement indicated that the thickness of the cholesteric liquid crystal layer was 1.5 μm.

The transmittance values Tmax and Tmin of the cholesteric liquid crystal layer were measured using “Axoscan” available from Axometrics, Inc. The reflectance R of the cholesteric liquid crystal layer was calculated from the following formula.

$$R ( \% ) = ( 1 - T min / T max ) \times 100$$

Tmax refers to the transmittance obtained when the polarization state of the incident light is set to yield the highest transmittance. Tmin refers to the transmittance obtained when the polarization state of the incident light is set to yield the lowest transmittance. The cholesteric liquid crystal layer exhibited the highest transmittance for incident right-handed circularly polarized light and the lowest transmittance for incident left-handed circularly polarized light.

FIG. 8 is a graph showing the reflectance of a cholesteric liquid crystal layer in Comparative Example 1. In FIG. 8, the maximum reflectance was normalized to 100%, and the selective reflection wavelength was observed at 650 nm. The maximum reflectance (reflectance at the wavelength of 650 nm) before normalization was 82%.

### Comparative Example 2

In Comparative Example 2, the selective reflection wavelength of a single-layer film of a polymerizable liquid crystal compound containing a chiral agent was evaluated using the same procedure as in Comparative Example 1, except that the concentration of the chiral agent was adjusted such that the selective reflection wavelength would be 550 nm.

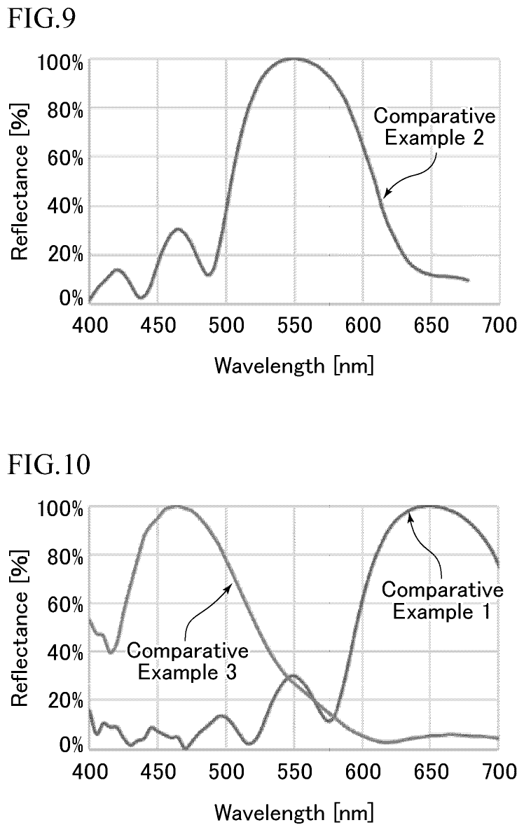

FIG. 9 is a graph showing the reflectance of a cholesteric liquid crystal layer in Comparative Example 2. In FIG. 9, the maximum reflectance was normalized to 100%, and the selective reflection wavelength was observed at 550 nm.

### Comparative Example 3

In Comparative Example 3, the selective reflection wavelength of a sample obtained by forming a single-layer film of a polymerizable liquid crystal compound containing a chiral agent and then applying a solvent to the film was evaluated. The sample was produced by the following procedure.
(1) A photoisomerization-type photoalignment film was formed on a glass substrate.
(2) The photoalignment film was irradiated with polarized ultraviolet (UV) light with a wavelength of 365 nm at 100 mJ/cm². Then, the photoalignment film was baked for 20 minutes in an oven at 160° C.
(3) The photoalignment film was coated with a polymerizable liquid crystal compound containing a chiral agent using a spin coater rotating at 1000 rpm. The concentration of the chiral agent was adjusted to be the same as in Comparative Example 1. The polymerizable liquid crystal compound exhibited positive wavelength dispersion, with the following relationships observed: Re (450 nm)/Re (550 nm)≈1.14; and Re (650 nm)/Re (550 nm)≈0.94.
(4) The applied polymerizable liquid crystal compound was irradiated with non-polarized UV light with a wavelength of 365 nm at 1 J/cm² to cure the polymerizable liquid crystal compound. The irradiation energy of the non-polarized UV light in Comparative Example 3 was smaller than that in Comparative Example 1, and the polymerizable liquid crystal compound was not fully cured at this time point. This state of curing is defined as a “partially cured” state.
(5) The partially cured polymerizable liquid crystal compound was coated with propylene glycol monomethyl ether acetate (PGMEA) as a solvent. The contact time between the polymerizable liquid crystal compound and the solvent was 5 seconds. After an elapse of 5 seconds, the solvent was removed by nitrogen blowing. The above process resulted in the completion of the sample.

The completed sample had a configuration in which the photoalignment film and the cholesteric liquid crystal layer were stacked on the glass substrate. The cholesteric liquid crystal layer contained a polymer of the polymerizable liquid crystal compound and the chiral agent.

The thickness of the cholesteric liquid crystal layer was measured using non-contact 3D measuring instrument “NH-3MA” available from Mitaka Kohki Co., Ltd. The measurement indicated that the thickness of the cholesteric liquid crystal layer was 1.2 μm, which was smaller than the thickness in Comparative Example 1.

The transmittance values Tmax and Tmin of the cholesteric liquid crystal layer were measured using “Axoscan” available from Axometrics, Inc. The reflectance R of the cholesteric liquid crystal layer was calculated. FIG. 10 is a graph showing the reflectance of cholesteric liquid crystal layers in Comparative Examples 1 and 3. In FIG. 10, the maximum reflectance values in Comparative Examples 1 and 3 were each normalized to 100%. In Comparative Example 3, the selective reflection wavelength of the cholesteric liquid crystal layer was observed at around 450 nm. The maximum reflectance (reflectance at the wavelength of 650 nm) before normalization in Comparative Example 1 was 82%, while the maximum reflectance (reflectance at the wavelength of 450 nm) before normalization in Comparative Example 3 was 78%.

As shown in FIG. 10, when a solvent is applied to the partially cured polymerizable liquid crystal compound, the thickness of the cholesteric liquid crystal layer decreases, and the reflection wavelength is shifted toward shorter wavelengths. This is due to the polymer diffusion.

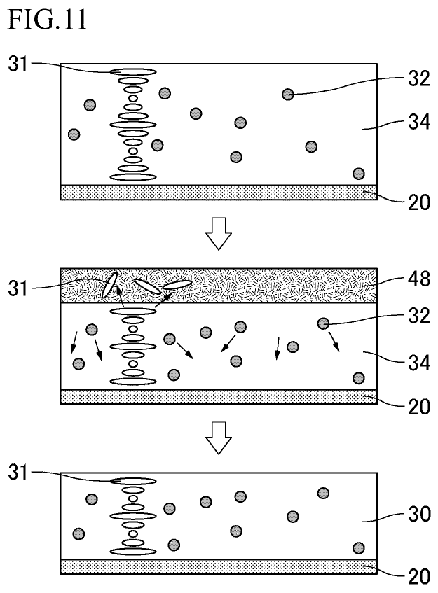

FIG. 11 is a flow diagram illustrating the mechanism by which the reflection wavelength of a cholesteric liquid crystal layer is shifted by applying a solvent to a partially cured polymerizable liquid crystal compound.

When the polymerizable liquid crystal compound 31 is irradiated with UV light and the obtained film 34 (partially cured film) of the polymerizable liquid crystal compound is coated with a solvent 48 such as propylene glycol monomethyl ether acetate (PGMEA), the uncured portion of the polymerizable liquid crystal compound 31 diffuses toward the solvent 48. Meanwhile, the chiral agent 32 diffuses toward the substrate (alignment film 20) without diffusing toward the solvent 48. In other words, it was found that after the solvent 48 is removed, the remaining cholesteric liquid crystal layer 30 exhibits a higher concentration of the chiral agent 32, resulting in a shift of the selective reflection wavelength toward shorter wavelengths, and that the removed solvent 48 contains a large amount of the polymerizable liquid crystal compound 31 and a small amount of the chiral agent 32. Additionally, the thickness of the cholesteric liquid crystal layer 30 decreases by the amount of the cholesteric liquid crystal layer 30 in the removed solvent 48. Such a mechanism is presumably caused by the difference in solubility in the solvent 48 between the polymerizable liquid crystal compound 31 and the chiral agent 32.

### Comparative Example 4

In Comparative Example 4, the selective reflection wavelength of a sample obtained by forming a single-layer film of a polymerizable liquid crystal compound containing a chiral agent and then applying a solvent to the film was evaluated. The sample was produced by the following procedure.
(1) A photoisomerization-type photoalignment film was formed on a glass substrate.
(2) The photoalignment film was irradiated with polarized ultraviolet (UV) light with a wavelength of 365 nm at 100 mJ/cm². Then, the photoalignment film was baked for 20 minutes in an oven at 160° C.
(3) The photoalignment film was coated with a polymerizable liquid crystal compound containing a chiral agent using a spin coater rotating at 1000 rpm. The concentration of the chiral agent was adjusted to be the same as in Comparative Example 1. The polymerizable liquid crystal compound exhibited positive wavelength dispersion, with the following relationships observed: Re (450 nm)/Re (550 nm)≈1.14; and Re (650 nm)/Re (550 nm)≈0.94.
(4) The applied polymerizable liquid crystal compound was irradiated with non-polarized UV light with a wavelength of 365 nm at 3 J/cm² to cure the polymerizable liquid crystal compound. The irradiation energy of the non-polarized UV light in Comparative Example 4 was adjusted to be greater than that in Comparative Example 3 and the same as that in Comparative Example 1. At this time point, the polymerizable liquid crystal compound was fully cured.
(5) The partially cured polymerizable liquid crystal compound was coated with propylene glycol monomethyl ether acetate (PGMEA) as a solvent. The contact time between the polymerizable liquid crystal compound and the solvent was 5 seconds. After an elapse of 5 seconds, the solvent was removed by nitrogen blowing. The above process resulted in the completion of the sample.

The completed sample had a configuration in which the photoalignment film and the cholesteric liquid crystal layer were stacked on the glass substrate. The cholesteric liquid crystal layer contained a polymer of the polymerizable liquid crystal compound and the chiral agent.

The thickness of the cholesteric liquid crystal layer was measured using non-contact 3D measuring instrument “NH-3MA” available from Mitaka Kohki Co., Ltd. The measurement indicated that the thickness of the cholesteric liquid crystal layer was 1.5 μm, which was the same as the thickness in Comparative Example 1.

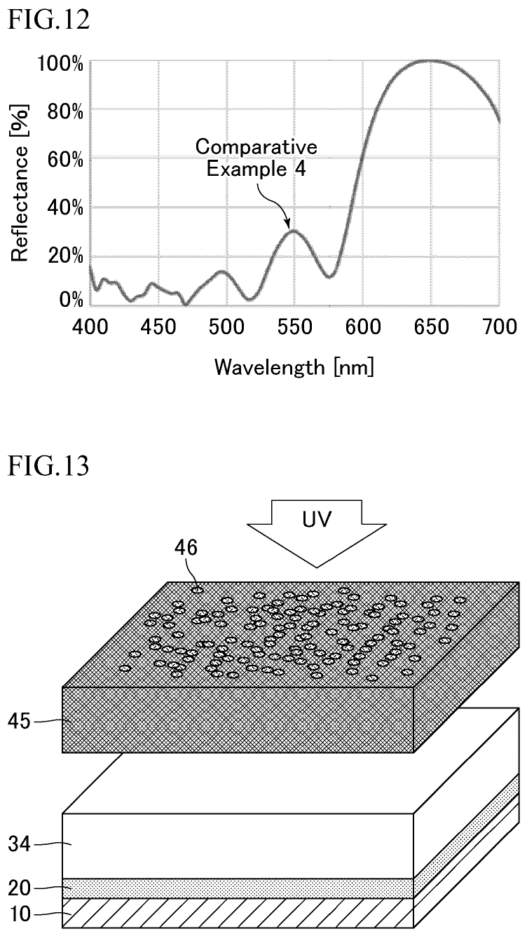

The transmittance values Tmax and Tmin of the cholesteric liquid crystal layer were measured using “Axoscan” available from Axometrics, Inc. The reflectance R of the cholesteric liquid crystal layer was calculated. FIG. 12 is a graph showing the reflectance of a cholesteric liquid crystal layer in Comparative Example 4. In FIG. 12, the maximum reflectance in Comparative Example 4 was normalized to 100%. In Comparative Example 4, the selective reflection wavelength of the cholesteric liquid crystal layer was observed at 650 nm, which was the same as in Comparative Example 1.

### Example 1

In Example 1, the selective reflection wavelength of a sample obtained by forming a partially cured region and a fully cured region of a polymerizable liquid crystal compound on one substrate and applying a solvent to the compound was evaluated. The sample in Example 1 was produced by the following procedure.
(1) A photoisomerization-type photoalignment film was formed on a glass substrate.
(2) The photoalignment film was irradiated with polarized ultraviolet (UV) light with a wavelength of 365 nm at 100 mJ/cm². Then, the photoalignment film was baked for 20 minutes in an oven at 160° C.
(3) The photoalignment film was coated with a polymerizable liquid crystal compound containing a chiral agent using a spin coater rotating at 1000 rpm. The concentration of the chiral agent was adjusted to be the same as in Comparative Example 1. The polymerizable liquid crystal compound exhibited positive wavelength dispersion, with the following relationships observed: Re (450 nm)/Re (550 nm)≈1.14; and Re (650 nm)/Re (550 nm)≈0.94.
(4) The applied polymerizable liquid crystal compound was irradiated with non-polarized UV light with a wavelength of 365 nm at 3 J/cm² through a half-tone mask to cure the polymerizable liquid crystal compound. FIG. 13 is a diagram showing curing treatment performed on a polymerizable liquid crystal compound in Example 1. As shown in the figure, a half-tone mask 45 used in Example 1 is a photomask having a region 46 with a transmittance of 30% and a region with a transmittance of 100%. The region 46 with a transmittance of 30% is distributed in a plurality of partial regions, and the region with a transmittance of 100% surrounds each of the plurality of partial regions. The area ratio of the region 46 with a transmittance of 30% and the region with a transmittance of 100% was 1:1. As a result of irradiation of the film 34 (uncured film) of the polymerizable liquid crystal compound with UV light through the half-tone mask 45, a region irradiated with UV light through the region 46 with a transmittance of 30% of the half-tone mask 45 became a region of a partially cured polymerizable liquid crystal compound, while a region irradiated with UV light through the region with a transmittance of 100% became a region of a fully cured polymerizable liquid crystal compound.
(5) The polymerizable liquid crystal compound after the UV irradiation was coated with propylene glycol monomethyl ether acetate (PGMEA) as a solvent. The contact time between the polymerizable liquid crystal compound and the solvent was 5 seconds. After an elapse of 5 seconds, the solvent was removed by nitrogen blowing. The above process resulted in the completion of the sample.

The completed sample had a configuration in which the photoalignment film and the cholesteric liquid crystal layer were stacked on the glass substrate. The cholesteric liquid crystal layer contained a polymer of the polymerizable liquid crystal compound and the chiral agent.

The thickness of the cholesteric liquid crystal layer was measured using non-contact 3D measuring instrument “NH-3MA” available from Mitaka Kohki Co., Ltd. The measurement indicated that the thickness of the partially cured region of the cholesteric liquid crystal layer after the UV irradiation was 1.2 μm, while the thickness of the fully cured region of the cholesteric liquid crystal layer after the UV irradiation was 1.5 μm.

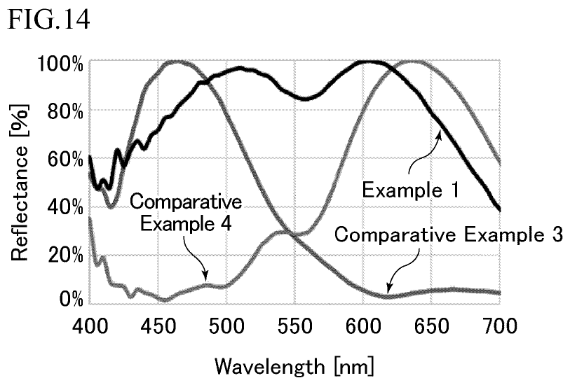

The transmittance values Tmax and Tmin of the cholesteric liquid crystal layer were measured using “Axoscan” available from Axometrics, Inc. The reflectance R of the cholesteric liquid crystal layer was calculated. FIG. 14 is a graph comparing the reflectance values of the cholesteric liquid crystal layers in Example 1, Comparative Example 3, and Comparative Example 4. In FIG. 14, the maximum reflectance values in Example 1, Comparative Example 3, and Comparative Example 4 were each normalized to 100%. The cholesteric liquid crystal layer in Example 1 includes a first reflective region having a reflectance peak (selective reflection wavelength) that falls within a wavelength range of 400 to 550 nm in the reflection spectrum, and a second reflective region having a reflectance peak (selective reflection wavelength) that is different from the reflectance peak of the first reflective region and falls within a wavelength range of 550 to 700 nm in the reflection spectrum. Such a reflection spectrum exhibits more uniform RGB light reflectance values than the reflection spectra of the cholesteric liquid crystal layers in Comparative Example 3 and Comparative Example 4. Here, the partially cured region with a smaller thickness of the cholesteric liquid crystal layer after the UV irradiation corresponds to the first reflective region, while the fully cured region with a greater thickness of the cholesteric liquid crystal layer after the UV irradiation corresponds to the second reflective region. Thus, the first reflective region is distributed in a plurality of partial regions, and the second reflective region surrounds each of the plurality of partial regions.

The results in Example 1 demonstrate that a diffraction element with a wide range of wavelengths of light capable of being reflected can be produced using a single-layer cholesteric liquid crystal layer. Although the area ratio of the first reflective region and the second reflective region was set to be 1:1 in Example 1, the area ratio may be changed depending on the material. Preferably, the area ratio is adjusted to achieve more uniform RGB reflectance values.

What is claimed is:

1. An optical element, comprising
a cholesteric liquid crystal layer containing a polymer of a polymerizable liquid crystal compound and a chiral agent,
the cholesteric liquid crystal layer including, within a plane, a first reflective region having a reflectance peak that falls within a wavelength range of 400 to 550 nm, and a second reflective region having a reflectance peak that is different from the reflectance peak of the first reflective region and falls within a wavelength range of 550 to 700 nm,
the cholesteric liquid crystal layer having a smaller thickness in the first reflective region than in the second reflective region.

2. The optical element according to claim 1,
wherein one of the first reflective region and the second reflective region is distributed in a plurality of partial regions, and the other of the first reflective region and the second reflective region surrounds each of the plurality of partial regions.

3. The optical element according to claim 2,
wherein a region in the cholesteric liquid crystal layer other than the plurality of partial regions corresponds to the other of the first reflective region and the second reflective region.

4. The optical element according to claim 1,
wherein in the cholesteric liquid crystal layer, reflectance at a wavelength of 450 nm in the first reflective region is higher than reflectance at a wavelength of 650 nm in the second reflective region, and an area of the first reflective region is smaller than an area of the second reflective region.

5. The optical element according to claim 1,
wherein in the cholesteric liquid crystal layer, reflectance at a wavelength of 450 nm in the first reflective region is lower than reflectance at a wavelength of 650 nm in the second reflective region, and an area of the first reflective region is greater than an area of the second reflective region.

6. The optical element according to claim 1,
wherein the cholesteric liquid crystal layer includes, within the plane, a low-reflective region having a lower visible reflectance than the first reflective region and the second reflective region.

7. The optical element according to claim 6,
wherein one of the first reflective region and the second reflective region is distributed in a plurality of first partial regions,
the low-reflective region is distributed in a plurality of second partial regions, and
a region in the cholesteric liquid crystal layer other than the plurality of first partial regions and the plurality of second partial regions corresponds to the other of the first reflective region and the second reflective region.

8. A light guide element, comprising:
a light guide plate;
a light incident-side optical element mounted on a light incident side of the light guide plate; and
a light emission-side optical element mounted on a light emission side of the light guide plate,
at least one of the light incident-side optical element or the light emission-side optical element is the optical element according to claim 1.

9. The light guide element according to claim 8,
wherein the light emission-side optical element includes, within a plane, the cholesteric liquid crystal layer including a low-reflective region having a lower visible reflectance than the first reflective region and the second reflective region, and
in the cholesteric liquid crystal layer, an area proportion of the low-reflective region is greater in a first region than in a second region which is farther from the light incident side of the light guide plate than the first region.

10. An AR display device, comprising:
the light guide element according to claim 8; and
a display module facing the light incident-side optical element.
